(19) United States
(12) Patent Application Publication
(10) Pub. No.: US 2008/0120302 A1
(43) Pub. Date: May 22, 2008

(54) Resource level role based access control for storage management

(76) Inventors: Timothy J. Thompson, San Jose, CA (US); James Hartwell Holl, Los Gatos, CA (US); William Raoul Durant, Alamo, CA (US)

Correspondence Address: NETWORK APPLIANCE/BLAKELY, 1279 OAKMEAD PARKWAY, SUNNYVALE, CA, 94085-4040, US

(21) Appl. No.: 11/601,096

(22) Filed: Nov. 17, 2006

(51) Int. Cl. G06F 17/00

(52) U.S. Cl. 707/9; 707/E17.059

(57) ABSTRACT

A method, apparatus, and system for providing role-based access control (RBAC) for storage management are described herein. Resource-identifying information is stored in a role-based access database for a network storage system, in association with role-identifying information for each of a plurality of roles and operation-identifying information. The operation-identifying information indicates one or more authorized operations for each of the plurality of roles and the resource-identifying information identifies specific resources maintained by the network storage system. The role-identifying information, data indicating one or more authorized operations for at least one of the roles, and resource-specific identifying information in the role-based access database are used to determine whether to allow or deny a request from a network storage client to access a resource maintained by the network storage system.

### FIELD OF THE INVENTION

Embodiments of the invention generally relate to storage systems. More particularly, an aspect of an embodiment of the invention relates to role-based access control for storage systems.

### BACKGROUND OF THE INVENTION

A common use of communication networks is to provide users access to network resources such as software, electronic data, or files in storage systems or databases connected to the network. As the number of users on a given network increases, there is often a need to control user access rights to resources on the network.

Network environments often involve a variety of network users, where the users may be grouped or categorized by a relation or role that the user serves in the environment. For example, in an engineering or technical development company environment, users of the company's computer network may include company officers, directors, managers, engineers, technical support staff, office support staff, accounting department staff, information technology (IT) department staff, contractors, consultants, temporary employees or other relation-based or role-based groups or categories of network users. Other companies, organizations or network environments may have other relation or role-based groups of users. Each user may have a need to access certain network resources in connection with the user's relation or role. In addition, it may be desirable to restrict users with certain relations or roles from access to certain resources, for example, for security, privacy or other reasons.

In many conventional businesses or organizations, specific personnel perform the function of managing users according to their roles. For example, an office administrator may place an order with the organization's IT department to have one or more resources available on the day a new user joins the organization. Individuals from the IT department would then manually set up these resources. Over the course of time, the user's relationship or roles within the organization may change, for example, as the user is transferred, promoted, demoted or terminated from the organization. As a user's relationship or role with the organization changes, the user's needs or rights to access resources may change.

The burden on the office administrator and office personnel to manually administer user access to resources in the above example is typically dependent on the size of the organization (the number of users) and the rate at which users join or leave the organization or otherwise change roles. To improve efficiency and reduce the burden on the office administrator and office personnel, some organizations have used software applications which automate or partially automate some of the tasks relating to managing certain, limited types of resources to users.

FIG. 1 illustrates a prior art method 100 of providing access control. At block 101, the prior art method 100 determines what operations a user is allowed to perform on one or more resources. At block 111, the prior art method 100 provides access control based on the operations the user can perform. Accordingly, if a user has been explicitly assigned a privilege to perform an operation on a resource, then the user can perform the operation. Thus, prior art method 100 uses a privilege-based access control system. Whenever a user or group of users is added to the system, an administrator must explicitly configure a set of privileges for each group of resources in the system. If a new resource is introduced, the administrator may need to modify the privileges of every user known to the system. As the number of users and resources grows, the usability of the system declines and security is reduced. Also, usability declines because users are not granted privileges that they need to complete their job functions because granular management is too expensive.

Because it is typically very inconvenient for a system administrator to provide each user with individual access rights and to achieve a higher grade of data security and integrity in a computer system, Role-Based Access Control (RBAC) methods have been developed. RBAC is one form of automatic access control management that has become commercially available. RBAC provides permissions (access rights) to a user to access certain accounts (files, web pages, etc.) available over the network, based on a person's role in the organization.

Therein, a role is mainly a definition of a job at the lowest level of granularity used in the enterprise or organization. In an RBAC system, the system administrator only has to grant or revoke access rights to a role and has to group different subjects under each role. Role-based access control (RBAC) is a system whereby access to resources is defined and controlled based on the role or job function of a user, rather than based on organizational group.

A prior art RBAC method includes associating operations to users. Accordingly, a role can perform one or more operations. For example, a role “Adminstrator” can perform backup of all files, while a role “CEO” can write to all files. Typically, a role is defined as a data structure that includes a two-column table with user ids in column and associated operations in the other column. For example, for the roles “Senior Administrator” and “Junior Administrator”, an example two column table 200 is shown in FIG. 2A. Thus, users with the role “Senior Administrator” can perform read, write and backup operations on all resources in the system, while users with the role “Junior Administrator” can perform only read and write operations on all resources in the system. This prior art method provides very little granularity as the system does not differentiate between resources.

Also, modern organizations may be structured along several intersecting lines. For example, organizations may be structured according to title (presidents, vice-presidents, directors, managers, supervisors, etc.), technology (electronics, mechanical, software, etc.), project (product A, B, C, etc.), location (Irvine, N.Y., etc.) and the like. A single user may appear in several or all of these organizational structures, and thus may be in a somewhat unique overall role as compared to other users in the organization. Because this may require that many users be provisioned uniquely, many unique roles would have to be defined in the system to further such managing. Also, a large number of similar but not identical job positions in an organization requires a large number of roles. This large number of roles causes a high storage requirement and high computing requirements for the security system within the computer system, leading to high costs for the operation of the security system. Furthermore, it is disadvantageous that the large number of roles makes it very difficult to manage the security system. The system administrator has to create a new role when a person remains in his job position but changes his location or project. Furthermore, a role includes the union of all operations and resources which users of that role have in different organization units of the enterprise. This means that the role will not necessarily contain the least permission necessary for the functions of that role.

An example of a computer system that requires that accesses to data by users are controlled is a business enterprise or other organization that manages large volumes of data and may operate multiple storage servers concurrently. These storage servers may be connected to each other through one or more networks. The storage servers and other network components may be managed by one or more network administrators (also called “administrative users” or simply “administrators”), who are responsible for configuring, managing and monitoring the storage servers, scheduling backups, troubleshooting problems with the storage servers, performing software upgrades, etc. These management tasks can be accomplished by the administrator using a separate management console on the network. The management console is a computer system that runs a storage management software application specifically designed to manage a distributed storage infrastructure. An example of such storage management software is DataFabric® Manager (DFM), which is made by Network Appliance, Inc. of Sunnyvale, Calif.

### SUMMARY OF THE INVENTION

Embodiments of the invention include methods and related apparatus for resource level role based access control for storage management. In one embodiment, resource-identifying information is stored in a role-based access database for a network storage system, in association with role-identifying information for each of a plurality of roles and operation-identifying information. The operation-identifying information indicates one or more authorized operations for each of the plurality of roles and the resource-identifying information identifies specific resources maintained by the network storage system. The role-identifying information, data indicating one or more authorized operations for at least one of the roles, and resource-specific identifying information in the role-based access database are used to determine whether to allow or deny a request from a network storage client to access a resource maintained by the network storage system.

Other aspects of the invention will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 is a flow diagram of a prior art method of providing access control;

FIG. 2 is an example of a table contained within a role in a prior art role based access control system;

FIG. 3A is a example of a table contained within a role in a role based access control system according to an embodiment;

FIG. 3B is a flow diagram of an embodiment of a method of providing resource level access control;

FIG. 4 illustrates a network environment in which the invention can be implemented;

FIG. 5 schematically shows the elements involved in the method of FIG. 3;

FIG. 6 is a flow diagram of an embodiment of a method of providing resource level access control;

FIG. 7 is a flow diagram of an embodiment of a method of providing localized objects to an RBAC system;

FIG. 8 schematically shows the elements involved in the method of FIG. 7; and

FIG. 9 is a high-level block diagram of a processing system.

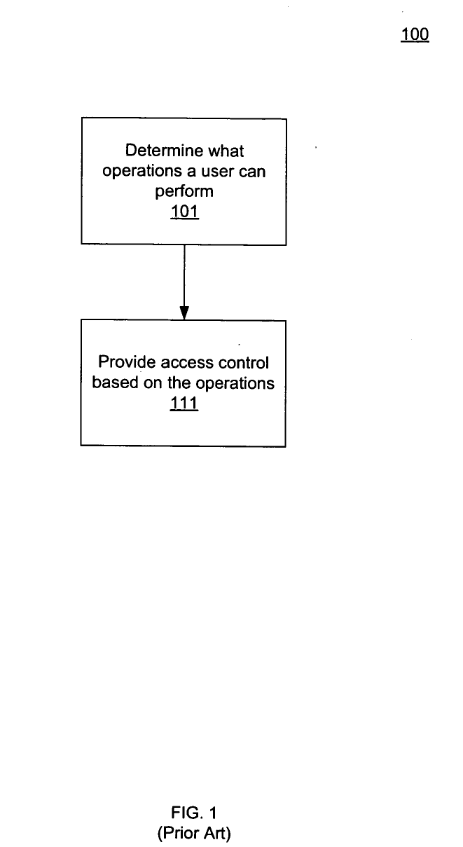

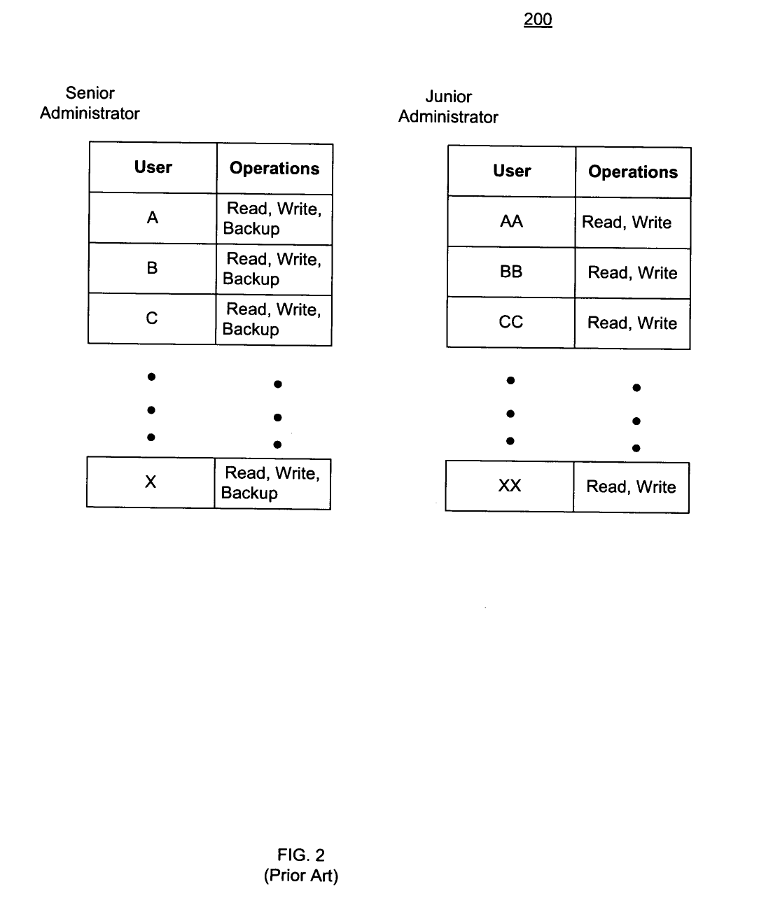

### DETAILED DISCUSSION

In the following description, numerous specific details are set forth, such as examples of specific data signals, named components, connections, number of memory columns in a group of memory columns, etc., in order to provide a thorough understanding of the present invention. It will be apparent, however, to one of ordinary skill in the art that the present invention may be practiced without these specific details. In other instances, well known components or methods have not been described in detail but rather in a block diagram in order to avoid unnecessarily obscuring the present invention. Further specific numeric references may be made. However, the specific numeric reference should not be interpreted as a literal sequential order but rather interpreted that the first driver is different than a second driver. Thus, the specific details set forth are merely exemplary. The specific details may be varied from and still be contemplated to be within the spirit and scope of the present invention. The term coupled is defined as meaning connected either directly to the component or indirectly to the component through another component.

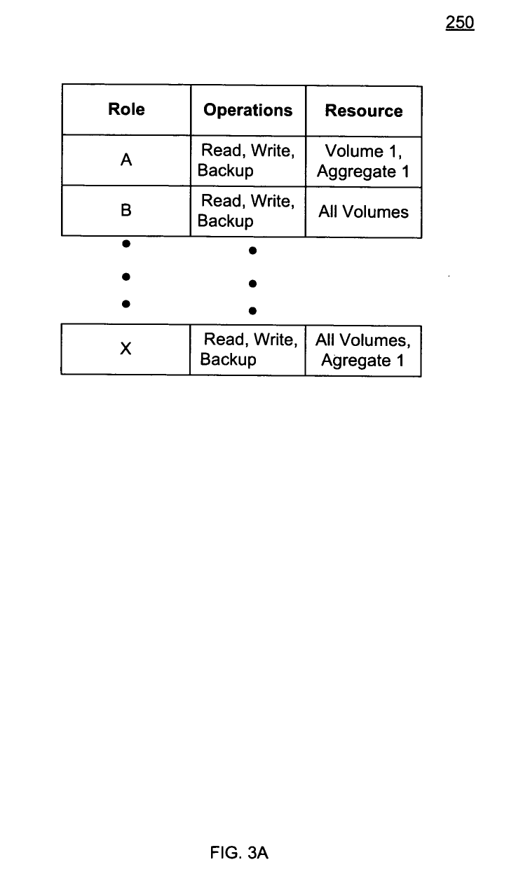

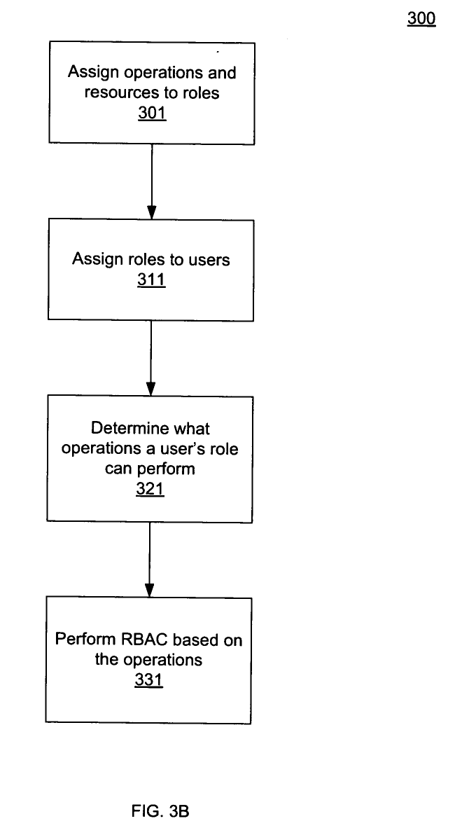

In general, the invention includes providing resource level role based access control (RBAC) with a high level of granularity. The resource level RBAC system assigns access to resources to roles, and then assigns roles to users or user groups. In one embodiment, the “role” data structure includes a three-column table, having as the three columns user or user groups, operation, and resources. For example, for the roles “Senior Administrator” and “Junior Administrator”, an example two column table 250 is shown in FIG. 3A. Thus, each user with the role “Senior Administrator” can perform read, write and backup operations on one or more specified resources in the system, while users with the role “Junior Administrator” can perform only read and write operations on one of more specified resources.

Roles are a set of capabilities that may be assigned to the users or user groups. A capability is an ability to perform an operation on a resource. Accordingly, a capability is defined by a resource and an operation. An operation is an action that an application allows a user to do, and may include read, write, back up, restore, delete, etc. A resource is an object on which an operation may be applied. For example, an administrative user with the “Role Administrator” role may create new roles and assign capabilities to them, while an administrative user with the “Backup Administrator” role may only backup data.

By specifying which resources a user can perform specified operations on, resource level RBAC systems can be used to provide a high degree of granularity. For instance, access control can be specified to all resources, down to each and every LUN.

Besides providing greater granularity, resource-level RBAC also provides greater security. Resource-level RBAC allows administrators to configure more secure systems by more tightly limiting the access of users. Further, even if a user with a role leaves the organization, not much updating needs to be done because a replacement user can be assigned to that role. Also, administrators are able to more easily add and remove resources and users and manage roles from a central management point.

Roles can be defined to closely match the requirements of a specific job function, and thus, can more accurately reflect the access hierarchy of an organization as opposed to a reporting hierarchy. For example, in an organization, the CEO might be on the top of the reporting hierarchy, but it may not be desirable that the CEO have access to delete technical data on a certain resource, such as on a certain LUN. Thus, the CEO's role can be defined such that the CEO does not have the capability to perform a delete operation on the technical data, but may have the capability of performing a read operation on such data. In this way, RBAC can be defined to more accurately provide the correct access control. Thus, embodiments of the invention mitigate the lack of access granularity by defining different roles based on access and resource contexts.

FIG. 3B illustrates a method 300 of providing resource level role-based access control according to an embodiment of the invention. Resource level role-based access control can be used to create permission to each and every system resource, such as every filer. This provides a lot more granularity than previous methods.

At block 301, the method 300 assigns operations and system resources to roles. Roles typically acquire capabilities (the ability to perform an operation on a resource) when either an administrator manually assigns the capability to the role or an inherited role acquires the capability. At block 311, the roles are assigned to users. An administrator can assign a role to a user or a user group. In the latter case, users added to the user group are automatically assigned the role. At block 321, upon receiving a request from a user to perform a particular operation on a resource, the method 300 uses a three-column table to determine what operations a user's role is allowed to perform on the resource. The table's first column entry may be a user, the second column entry is the operation(s) the role is allowed to perform, and the third entry is one or more resources on which that operation can be performed. For example, the table may include as (user, operation, resource) entries: (user 1, read, volume 1), (user 1 write, filer 1), (user 1, backup, LUN1), (user 2 read, aggregate 1), and so on.

At block 331, the method 300 provides access control based on the operations the user's role can perform. As an example, say that user “jimholl” is in user group “Storage Mangement.” The user group “Storage Management” has been assigned the “Software Developer” role. The “Software Developer” role inherits from the “Employee” role, which contains a capability consisting of the “DFM.Database.Read” operation in the global scope (resource 0). Therefore, when jimholl tries to read (DFM.Database.Read) the list of filers in say, NetApp Bangalore, he is granted access.

Thus, method 300 uses a resource level role-based access control system based on the operations the user is allowed to perform.

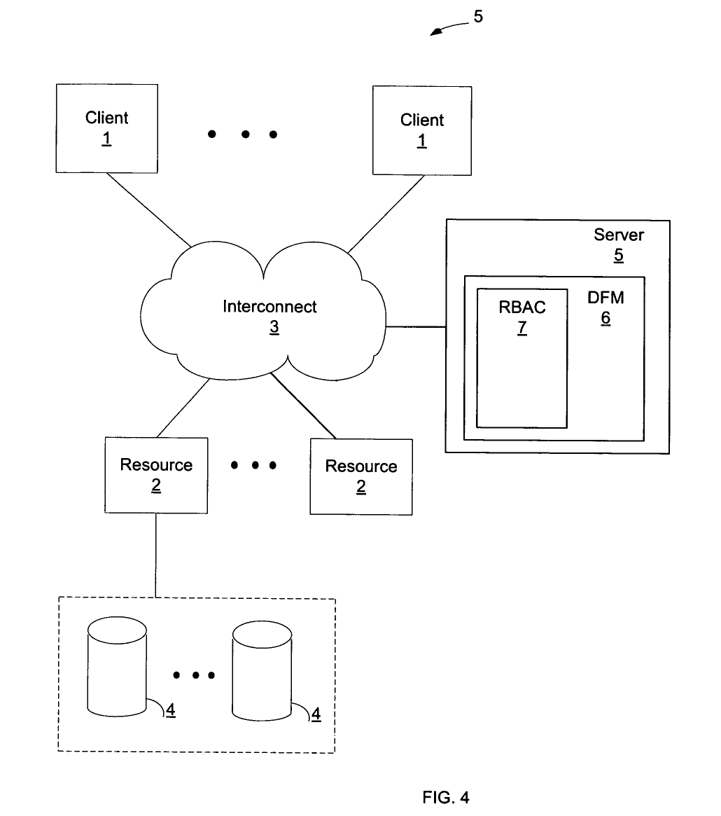

FIG. 4 shows a network environment in which the invention can be implemented. In FIG. 4, a number of resources 2 (as described below) are coupled through a network 3 to a number of clients 1. A resource 2, such as a storage server, may be coupled locally to a separate storage subsystem 4, which includes multiple mass storage devices. Each storage subsystem 4 is managed by its corresponding server 900. A server 5 receives and responds to various administrative requests (read, write, back up, delete, restore, etc.) from the clients 1, directed to a resource 2. The server 5 may be a storage management console which comprises storage management software, such as DFM 6, to perform the resource level RBAC and other storage management related functions. Integrated with DFM is the resource level RBAC module 7.

A resource 2 may include appliances, aggregates, volumes, LUNs, filers (file servers used in a NAS mode), virtual filers (virtual file servers), hosts, and so on. A volume is an independent file system with its own RAID groups. The network 3 may be, for example, a local area network (LAN), a wide area network (WAN), or other type of network or a combination of networks. The mass storage devices in storage subsystem 4 may be, for example, conventional magnetic disks, optical disks such as CD-ROM or DVD based storage, magneto-optical (MO) storage, or any other type of non-volatile storage devices suitable for storing large quantities of data. The storage devices in storage subsystem 4 can be organized as a Redundant Array of Inexpensive Disks (RAID), in which case the corresponding server 900 accesses the storage subsystem 4 using an appropriate RAID protocol.

The server-side implementation of the resource level RBAC system 7, as illustrated in FIG. 4, reduces the need for a client 1 to make multiple client/server API calls, thus, improving the performance of functions requiring mass access checks (such as reporting). Also, different clients 1 do not have to implement and maintain multiple RBAC implementations because they share the server implementation. Further, server-side caching techniques (e.g., group caching) can be used to accelerate request handling at the server 5. In one embodiment of the invention, there are several different server-side caches. For example, the contents of a filer may be determined by determining the list of aggregates it contains, the volumes in those aggregates and the qtrees in those volumes (and many other things). Rather than re-computing this list of contents every time such knowledge is desired, the results of the computation are cached and track kept of whether or not something has happened to invalidate the cache.

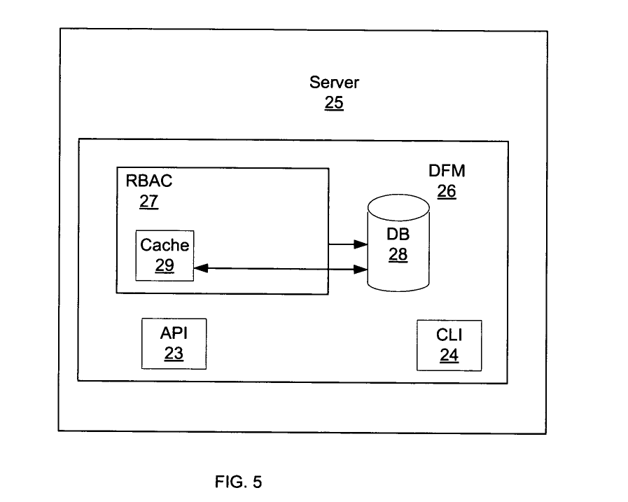

FIG. 5 illustrates a block diagram of a server 25, which includes storage management software to perform the resource level RBAC and other storage management related functions according to an embodiment of the invention. The storage management software DFM 26 is integrated with the resource level RBAC 27, and includes a database 28. The server 25 may be a server running one of many operating systems, such as Solaris (from Sun), Microsoft Windows or Linux. The compatibility matrix is more detailed and varies by release. Database 28 may include an objects table to store object types that are managed by the RBAC 27, a table to map users and usergroups to roles, a table to define the access rights assigned to the roles, a table defining the available operations, a table to describe the hierarchical relationships between roles, and a table listing the available roles. The information stored in the database 28 is used to determine whether a user has a particular type of access to a resource. Accordingly, a user may be granted access based on any of the roles the user has, or by any of the roles inherited by the roles that the user has. Also, the user may be granted access because the user is a member of a usergroup with the necessary capabilities.

The resource level RBAC 27 also includes a cache 29. The cache 29 is used to store results of queries made to database 28. Results of other database queries, as are described in more detail with reference to FIG. 4, may be stored in the cache 29 since database queries are expensive. In one embodiment, when a user logs onto to DFM 26, DFM 26 authenticates the user and determines what roles the user has, and what capabilities the user has in each role. This information may then be cached in cache 29. The cache 29 may be invalidated upon detecting change in environment, e.g., change in the roles associated with a user.

Also included in DFM 26 may be interfaces, such as command line interfaces (CLIs) 24, and Application Program Interfaces (APIs) 23. The APIs 23 may be used by external applications to make security checks against RBAC 27, and to manage their own RBAC information. In this way, even external applications can make avail of a single RBAC system as a uniform and consistent authorization mechanism.

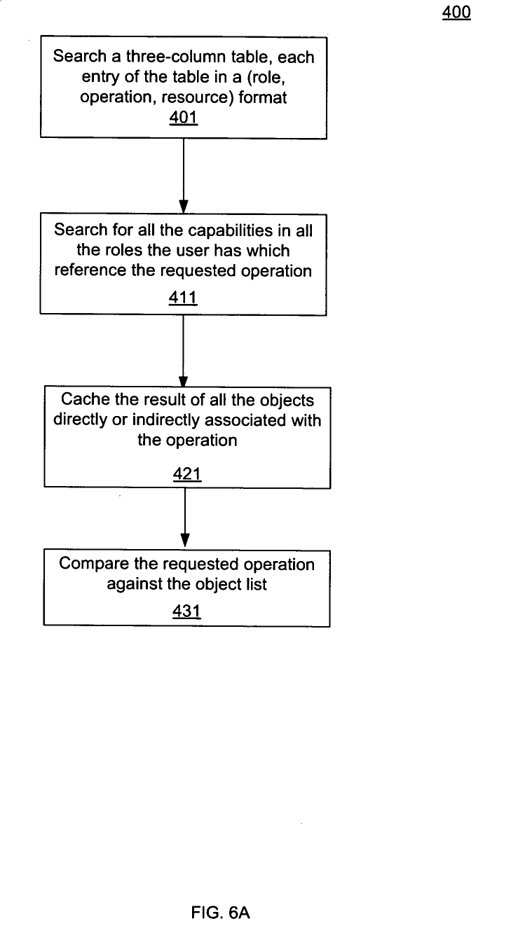

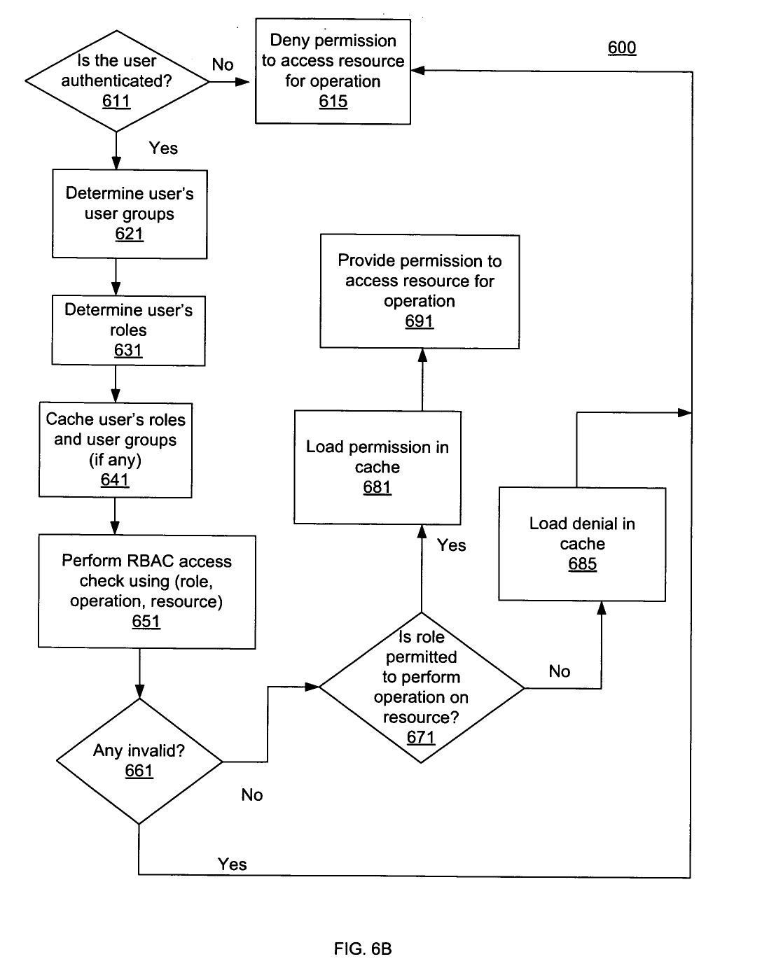

FIG. 6 illustrates a flowchart of a method performed 600 according to an embodiment of the invention to provide resource level role-based access to a user for performing a particular operation (e.g., read, write, back up, delete, etc) on a particular resource (e.g. filer, volume, aggregate, LUN, etc.).

At block 611, the user is authenticated, e.g., by using the user's login identification and one or more passwords. If the user's identity cannot be verified, access to the user is denied at block 615. Otherwise, at block 621, the method determines which user groups the user belongs to, in order to determine the roles that the user inherits from the user groups. The usergroups to which the user belongs and the user's roles may be cached, e.g., in cache 29, at block 641. Because the caching can be done when the user is authenticated for the first time, the user's roles are available whenever an RBAC access check is needed without re-determining them.

At block 651, an RBAC access check is performed by using the user's role information, the operation to be performed, and the resource on which the operation is to be performed. At block 661, if it determined that any of these three parameters is invalid, e.g., if a resource has been deleted, then user is denied access to perform the operation. Otherwise, at block 671, the database 28 is queried to determine if one of the user's role is permitted to perform the requested operation on the resource in question. A role may be permitted to perform an operation on a resource, if the role is a super-user role (that is, the role enables all operations on all resources), or if the operation is always allowed, or if the resource in question is a member of a resource group that the role is permitted to perform the operation on. At block 681 and 685, information about allowance and denial respectively is saved in cache 29. Accordingly, if the next time, the user wishes to perform the same operation on the same resource, time and computing power is saved as the access permission can be readily obtained from the cache 29, without making too many database 28 queries.

In one embodiment of the invention, resource level RBAC system is localized. Accordingly, an administrator can define roles and operations in multiple languages and allow clients of the resource level RBAC system to interact with the system according to the client's locale. Typically, default roles, default operations, and roles/operations added by RBAC clients are named with a single string in one language. As an example, one of the default roles, “GlobalRead,” may be assigned to users all over the world. Some of them may prefer a localized role name more appropriate for their country. This can make management of the RBAC system difficult for administrators in different locales.

According to one embodiment of the invention, when a role or operation is added to a RBAC system by a client, a client can specify multiple locale-dependent names for the role or operation. The message catalogs can be added, deleted, modified, or otherwise managed by an administrator. The message catalogs may be managed directly by an administrator or through object-specific APIs. Further, management interfaces for roles and operations can be used to modify one or more of the message catalog entries.

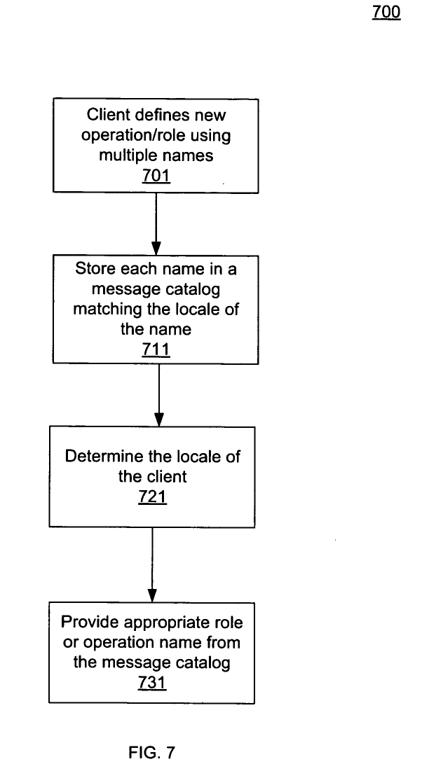

FIG. 7 illustrates a method of adding localized objects (such as role and operation) to a system by specifying one or more localized names. At block 701, a client defines a new operation or role in multiple locale-dependent languages. At block 711, the RBAC system stores each name in a message catalog matching the locale of the name. The message catalogs may be stored in a database connected to the RBAC module, such as database 28 to avoid security problems associated with storing the message catalog on its respective locale. In one embodiment, a message catalog is provided for each locale to store each name by the RBAC system. This adds security over a system in which the name of a role or operation is stored in a single message catalog, and then translated for each locale. At block 721, when sending information about a role or operation to a client, the RBAC system determines the locale of the client. At block 731, the RBAC system uses the client's locale to provide the appropriate role or operation name from the message catalog associated with the client's locale. Thus, FIG. 7 illustrates adding localized objects to an RBAC system by specifying one or more localized names.

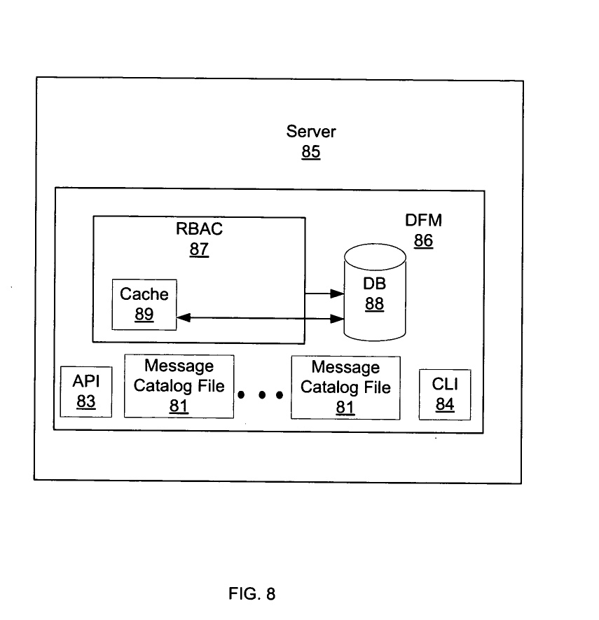

FIG. 8 illustrates a block diagram of a server 85, which includes storage management software to perform the resource level RBAC and other storage management related functions according to an embodiment of the invention. The server 85 is similar to server 25 illustrated in FIG. 5, except in that it includes multiple message catalog files that contain localized objects.

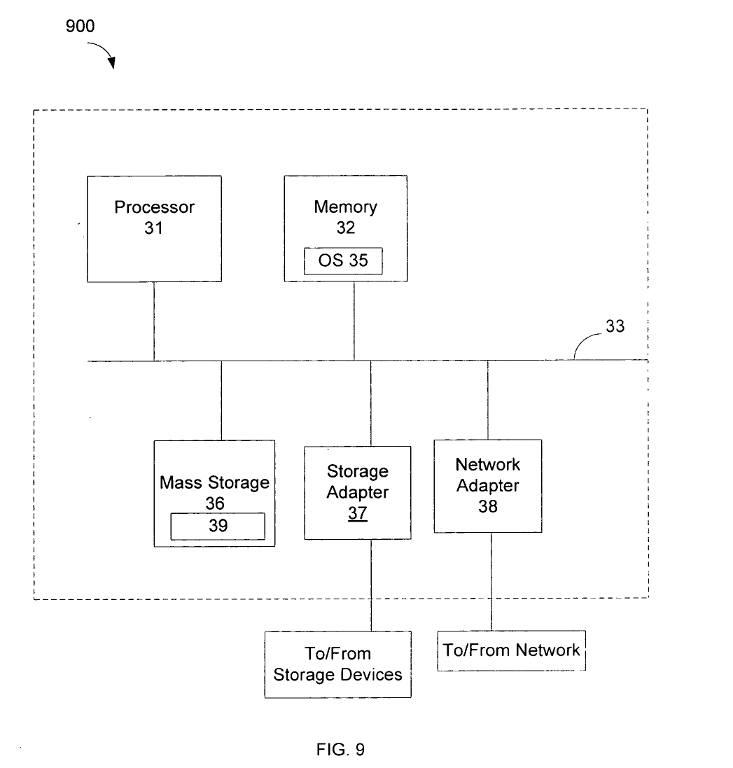

FIG. 9 is a high-level block diagram of a server 900, which can be implement embodiments of the invention. Certain standard and well-known components which are not germane to the present invention are not shown. The storage server 900 in the illustrated embodiment includes a processor 31 coupled to a bus system 33. The bus system 33 is an abstraction that represents any one or more separate physical buses and/or point-to-point connections, connected by appropriate bridges, adapters and/or controllers. The bus system 33, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processor 31 is the central processing units (CPUs) of the server 900 and, thus, control the overall operation of the server 900. In certain embodiments, the physical processor 31 accomplishes this by executing software stored in memory 32. A physical processor 31 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The server 900 also includes memory 32 coupled to the bus system 43. The memory 32 represents any form of random access memory (RAM), read-only memory (ROM), flash memory, or a combination thereof. Memory 32 stores, among other things, the operating system 35 of the server 900, in which the techniques introduced here can be implemented.

Also connected to the processor 31 through the bus system 33 are a mass storage device 36, a storage adapter 37, and a network adapter 38. Mass storage device 36 may be or include any conventional medium for storing large quantities of data in a non-volatile manner, such as one or more disks. The storage adapter 37 allows the server 900 to access the external mass storage devices 4 and may be, for example, a Fibre Channel adapter or a SCSI adapter. The network adapter 38 provides the server 900 with the ability to communicate with remote devices such as the clients 1 over a network and may be, for example, an Ethernet adapter or a Fibre Channel adapter.

Memory 32 and mass storage device 36 store software instructions and/or data 35 and 39, which may include instructions and/or data used to implement the techniques introduced here. These instructions and/or data may be implemented as part of the operating system 35 of the server 900.

In one embodiment, the software used to facilitate the algorithm can be embodied onto a machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; Digital VideoDisc (DVD's), electrical, optical, acoustical or other form of propagated signals (e.g., carrier waves, infrared signals, digital signals, EPROMs, EEPROMs, FLASH memory, magnetic or optical cards, or any type of media suitable for storing electronic instructions. Slower mediums could be cached to a faster, more practical, medium.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “determining” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

What is claimed is:

1. A method comprising:
storing, in a role-based access database for a network storage system, resource-identifying information in association with role-identifying information for each of a plurality of roles and operation-identifying information, the operation-identifying information indicating one or more authorized operations for each of the plurality of roles, the resource-identifying information identifying specific resources maintained by the network storage system; and
using the role-identifying information, data indicating one or more authorized operations for at least one of the roles, and resource-specific identifying information in the role-based access database, to determine whether to allow or deny a request from a network storage client to access a resource maintained by the network storage system.

2. The method recited in claim 1, the network storage system stores the resources.

3. The method recited in claim 1, further comprising:
providing a table having a plurality of columns, the table including a plurality of entries, each of the plurality of entries including data indicating one or more authorized operations for one of the roles on or more resources.

4. The method recited in claim 3, further comprising:
in response to receiving the request from the network storage client to access the resource maintained by the network storage system, determining one or more roles assigned to the first user; and
looking up the table provided to the one or more roles assigned to the first user to determine whether the user can perform the requested operation on the second resource.

5. The method recited in claim 3, further comprising:
caching the one or more roles assigned to the user and whether the one or more roles assigned to the user can perform the operation on the resource.

6. The method recited in claim 3, wherein determining whether the user's role can perform the operation on the resource comprises:
determining whether the user belongs to one or more user groups; and
associating with the user one or more roles assigned to the one or more user groups.

7. The method recited in claim 3, wherein determining whether the one or more roles assigned to the user can perform the operation on the resource comprises:
performing an RBAC access check using the one or more roles assigned to the user, the operation, and the resource.

8. A method comprising:
receiving a request from a network storage client to perform a first operation, of a plurality of possible operations, on a first resource of a plurality of resources stored by a network storage system; and
determining whether the request should be serviced by consulting a data structure that contains data identifying a plurality of roles and, for each role, data indicating at least one of the plurality of possible operations that said role permitted to perform, the data structure further including, for at least one of said operations, data indicating at least one of the plurality of resources upon which said operation is permitted to be performed by the corresponding user.

9. The method recited in claim 8, further comprising:
providing a table having a plurality of columns, the table including a plurality of entries, each of the plurality of entries including data indicating one or more authorized operations for one of the roles on one or more resources.

10. The method recited in claim 9, further comprising:
in response to the client request, determining one or more roles assigned to the first user; and
looking up the table to determine whether the user can perform the requested operation on the second resource.

11. The method recited in claim 10, further comprising:
caching the one or more roles assigned to the user and whether the one or more roles assigned to the user can perform the operation on the resource.

12. The method recited in claim 10, further comprising:
determining whether the user belongs to one or more user groups; and
associating with the user one or more roles assigned to the one or more user groups.

13. A method comprising:
in a network storage system that provides role-based access control (RBAC), enabling a plurality of clients of the network storage system to specify descriptions of roles or operations or both in a plurality of languages, wherein each of the plurality of clients is located at a different locale; and
sending a specified description of a role or an operation to a first client of the plurality of clients in a particular language selected based on a locale of said first client.

14. The method recited in claim 13, further comprising:
storing each description in a plurality of message catalogs corresponding to the plurality of clients, a single message catalog associated with each language.

15. The method recited in claim 13, further comprising:
using the locale of a client to send information about one of a role or operation to the client in a locale-specific language.

16. The method recited in claim 14, wherein the plurality of message catalogs is stored on a server on which the RBAC system is located.
